(19) United States
(12) Patent Application Publication
(10) Pub. No.: US 2026/0369473 A1
(43) Pub. Date: Nov. 19, 2026

(54) MULTILAYER CERAMIC ELECTRONIC COMPONENT

(71) Applicant: Murata Manufacturing Co., Ltd., Nagaokakyo-shi (JP)

(72) Inventor: Kota ZENZAI, Nagaokakyo-shi (JP)

(21) Appl. No.: 19/745,536

(22) Filed: Jul. 17, 2026

Related U.S. Application Data
(63) Continuation of application No. PCT/JP2024/035086, filed on Oct. 1, 2024.

(30) Foreign Application Priority Data
Jan. 29, 2024 (JP) 2024-011160

(51) Int. Cl. H01G 2/06; H01G 4/12; H01G 4/232; H01G 4/248; H01G 4/30

(52) U.S. Cl. CPC H01G 2/065; H01G 4/12; H01G 4/232; H01G 4/248; H01G 4/30

(57) ABSTRACT

A multilayer ceramic electronic component includes a multilayer body including two main surfaces facing each other in a lamination direction in which dielectric layers and inner electrode layers are laminated and two end surfaces facing each other in a length direction. The multilayer ceramic electronic component includes two outer electrodes that each cover the end surface and, continuously from the end surface, a portion of the two main surfaces at a respective one of the two end surfaces, and two spacers on one of the two main surfaces. The spacers each include first and second regions arranged in the lamination direction such that the first region is in contact with the outer electrode and the second region is not in contact with the outer electrode. The second region has a higher Sn content percentage and/or a higher resin content percentage than the first region.

### CROSS REFERENCE TO RELATED APPLICATIONS

This application claims the benefit of priority to Japanese Patent Application No. 2024-011160 filed on Jan. 29, 2024 and is a Continuation Application of PCT Application No. PCT/JP2024/035086 filed on Oct. 1, 2024. The entire contents of each application are hereby incorporated herein by reference.

### BACKGROUND OF THE INVENTION

### 1. Field of the Invention

The present invention relates to multilayer ceramic electronic components such as multilayer ceramic capacitors.

### 2. Description of the Related Art

Multilayer ceramic electronic components such as multilayer ceramic capacitors are widely used in mobile terminal devices such as cellular phones or various electronic devices such as personal computers. The multilayer ceramic capacitor includes a rectangular parallelepiped multilayer body in which dielectric layers and inner electrode layers are alternately laminated, and outer electrodes formed at both opposing ends of the multilayer body.

The multilayer ceramic capacitor has an inner layer portion in which the dielectric layers and inner electrodes are alternately laminated. Further, dielectric layers as outer layer portions are disposed on the upper and lower sides of the inner layer portion to form a multilayer body having a rectangular parallelepiped shape, and outer electrodes are disposed on both end surfaces of the multilayer body in a longitudinal direction, thereby forming a capacitor body.

Moreover, there is known a multilayer ceramic capacitor including a spacer (metal frame) formed on a side of mounting on a substrate in the capacitor body so as to cover a portion of the outer electrode for reducing or preventing the occurrence of so-called “acoustic noise” (U.S. Pat. No. 9,799,453).

### SUMMARY OF THE INVENTION

However, if solder that is heated and molten during mounting travels along a surface of the spacer and spreads upward to a high position in a height direction of the multilayer ceramic capacitor, it sometimes becomes difficult to reduce or prevent acoustic noise because expansion/contraction vibration of the inner layer portion propagates to a mounting substrate.

Example embodiments of the present invention provide multilayer ceramic electronic components such as multilayer ceramic capacitors that reduce the amount of solder in mounting and reduce or prevent acoustic noise.

The present inventor has discovered that the amount of solder in mounting can be reduced and the occurrence of acoustic noise can be reduced or prevented by dividing a spacer into a first region located on a capacitor body side and a second region located on a mounting substrate side and making a Sn content percentage and/or a resin content percentage higher in the second region than in the first region.

That is, an example embodiment of the present invention provides a multilayer ceramic electronic component including a multilayer body including an inner layer portion in which dielectric layers and inner electrode layers are alternately laminated, two main surfaces facing each other in a lamination direction, two end surfaces facing each other in a length direction intersecting the lamination direction, and two side surfaces facing each other in a width direction intersecting the lamination direction and the length direction, two outer electrodes that are each connected to the inner electrode layers and each cover a respective one of the two end surfaces and, continuously from the end surface, a portion of the two main surfaces facing each other, at a respective one of the two end surfaces, and two spacers located on one side of the two main surfaces of the multilayer body, wherein the two spacers include a first region and a second region arranged in the lamination direction such that the first region is in contact with a respective one of the two outer electrodes and the second region is not in contact with the two outer electrodes, and the second region has a higher Sn content percentage and/or a higher resin content percentage compared with the first region.

According to example embodiments of the present invention, it is possible to provide multilayer ceramic electronic components such as multilayer ceramic capacitors that each reduce the amount of solder in mounting and reduce or prevent acoustic noise.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a diagram depicting an external appearance of a multilayer ceramic capacitor 1.

FIG. 2 is a cross-sectional view of the multilayer ceramic capacitor 1 taken along line II-II depicted in FIG. 1.

FIG. 3 is a cross-sectional view of the multilayer ceramic capacitor 1 taken along line III-III depicted in FIG. 1.

FIG. 4 is a cross-sectional view of a spacer 4 when the multilayer ceramic capacitor 1 is mounted (first example).

FIG. 5 is a cross-sectional view of the spacer 4 when the multilayer ceramic capacitor 1 is mounted (second example).

FIG. 6 is a cross-sectional view of the spacer 4 when the multilayer ceramic capacitor 1 is mounted (third example).

FIG. 7 is a cross-sectional view of the spacer 4 when the multilayer ceramic capacitor 1 is mounted (fourth example).

FIG. 8 is an enlarged cross-sectional view of a portion of a first region 41 when a phenolic resin is used.

FIG. 9 is an enlarged cross-sectional view of a portion of the first region 41 when an epoxy resin is used.

FIG. 10 is a flowchart depicting a manufacturing method for the multilayer ceramic capacitor 1.

FIGS. 11A to 11D are diagrams for explaining a multilayer body manufacturing step S1, an underlying electrode layer forming step S2, and a plated layer forming step S3.

FIG. 12 is a sectional view of the multilayer ceramic capacitor 1 in which an insulating material 50 is disposed.

### DETAILED DESCRIPTION OF THE EXAMPLE EMBODIMENTS

Multilayer ceramic capacitors are described below as example embodiments of the multilayer ceramic electronic components of the present invention. However, the present invention is not limited thereto. Further, in some cases, the drawings are schematically depicted in a simplified manner for describing the content of the invention, and the ratio of dimensions in a depicted component or between depicted components does not coincide with the ratio of these dimensions described in the specification. In addition, there are a case in which a component described in the specification is omitted in the drawing, a case in which a component described in the specification is depicted with a reduced number of components for simplification, and the like.

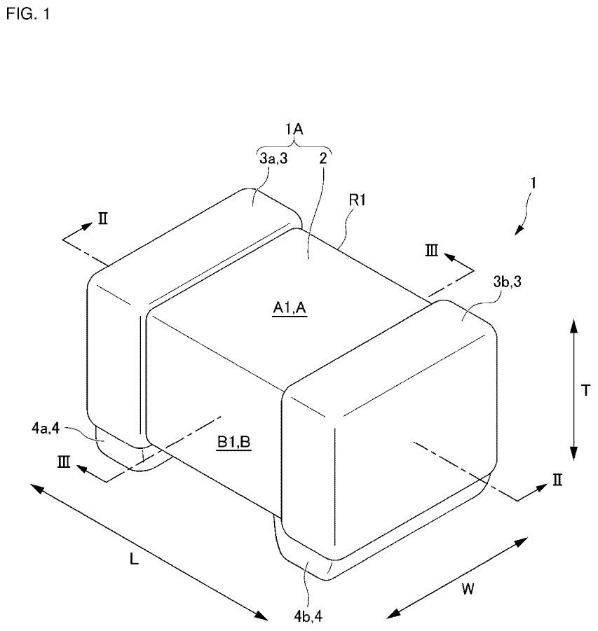

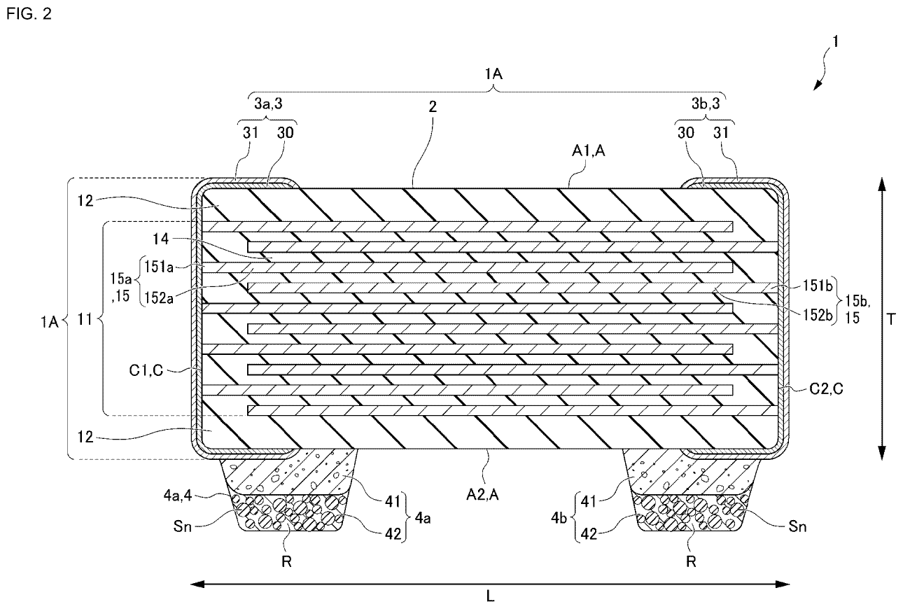

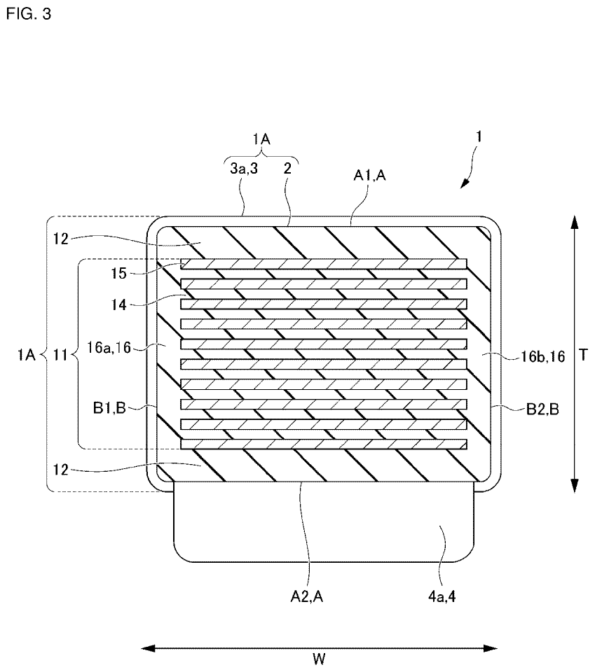

FIG. 1 is a schematic perspective view of the multilayer ceramic capacitor 1 of the present example embodiment. FIG. 2 is a cross-sectional view of the multilayer ceramic capacitor 1 of the present example embodiment taken along line II-II in FIG. 1. FIG. 3 is a cross-sectional view of the multilayer ceramic capacitor 1 of the present example embodiment taken along line III-III in FIG. 1. FIG. 2 is a cross section parallel to a length direction L and a lamination direction T, and is also referred to as an LT cross section. Further, FIG. 3 is a cross section parallel to a width direction W and the lamination direction T, and is also referred to as a WT cross section.

The multilayer ceramic capacitor 1 includes a capacitor body 1A that has a substantially rectangular parallelepiped shape and includes a multilayer body 2 and a pair of outer electrodes 3 disposed at both ends of the multilayer body 2, and spacers 4 attached to the capacitor body 1A. Further, the multilayer body 2 includes an inner layer portion 11 in which dielectric layers 14 and inner electrode layers 15 are laminated.

In the following description, as a term representing an orientation of the multilayer ceramic capacitor 1, a direction in which the pair of outer electrodes 3 are disposed in the multilayer ceramic capacitor 1 is defined as the length direction L. A direction in which the dielectric layers 14 and the inner electrode layers 15 are laminated is defined as the lamination direction T. A direction intersecting both the length direction L and the lamination direction T is defined as the width direction W. In the present example embodiment, the width direction W is orthogonal to both the length direction L and the lamination direction T.

Further, among six outer surfaces of the multilayer body 2, a pair of outer surfaces facing each other in the lamination direction T are defined as a first main surface A1 and a second main surface A2. Further, a pair of outer surfaces facing each other in the width direction W are defined as a first side surface B1 and a second side surface B2. In addition, a pair of outer surfaces facing each other in the length direction L are defined as a first end surface C1 and a second end surface C2. When it is not required to particularly distinguish between the first main surface A1 and the second main surface A2, they are collectively referred to as the main surfaces A. When it is not required to particularly distinguish between the first side surface B1 and the second side surface B2, they are collectively referred to as the side surfaces B. When it is not required to particularly distinguish between the first end surface C1 and the second end surface C2, they are collectively referred to as the end surfaces C.

It is preferable that ridge portions R1 including corner portions be rounded in the multilayer body 2. The ridge portion R1 is a portion where two surfaces of the multilayer body 2, that is, the main surface A and the side surface B, the main surface A and the end surface C, or the side surface B and the end surface C, intersect each other.

The multilayer body 2 includes the inner layer portion 11 that generates electrostatic capacitance, outer layer portions 12 disposed on both sides of the inner layer portion 11 in the lamination direction T, and side margin portions 16 disposed on both sides of the inner layer portion 11 and the outer layer portions 12 in the width direction W.

The inner layer portion 11 includes the dielectric layers 14 and the inner electrode layers 15 alternately laminated along the lamination direction T.

The dielectric layer 14 is made of a ceramic material. As the ceramic material, for example, a dielectric ceramic including BaTiO₃ as a main component is used.

The inner electrode layers 15 include a plurality of first inner electrode layers 15a and a plurality of second inner electrode layers 15b. The first inner electrode layers 15a and the second inner electrode layers 15b are alternately disposed. The first inner electrode layers 15a each include a first opposing portion 152a opposed to the second inner electrode layer 15b and a first extended portion 151a extended from the first opposing portion 152a toward the first end surface C1 side. End portions of the first extended portions 151a are exposed at the first end surface C1, and are electrically connected to a first outer electrode 3a to be described later. The second inner electrode layers 15b each include a second opposing portion 152b opposed to the first inner electrode layer 15a and a second extended portion 151b extended from the second opposing portion 152b to the second end surface C2. End portions of the second extended portions 151b are electrically connected to a second outer electrode 3b to be described later.

It is preferable that the inner electrode layer 15 include a metal material typified by, for example, Ni, Cu, Ag, Pd, a Ag−Pd alloy, Au, or Sn, or the like.

The outer layer portion 12 can include the same material as the dielectric layer 14 of the inner layer portion 11.

The side margin portions 16 are disposed on both sides of the inner layer portion 11 and the outer layer portions 12 in the width direction W, and include a first side margin portion 16a defining the first side surface B1 of the multilayer ceramic capacitor 1 and a second side margin portion 16b defining the second side surface B2 of the multilayer ceramic capacitor 1. The side margin portion 16 can include the same material as that of the dielectric layer 14.

The outer electrodes 3 include the first outer electrode 3a disposed on the first end surface C1 and the second outer electrode 3b disposed on the second end surface C2. The outer electrodes 3 each cover not only the end surface C but also portions of the main surfaces A and the side surfaces B that continue from the end surface C.

As described above, the end portions of the first extended portions 151a of the first inner electrode layers 15a are exposed at the first end surface C1, and are electrically connected to the first outer electrode 3a. Further, the end portions of the second extended portions 151b of the second inner electrode layers 15b are exposed at the second end surface C2, and are electrically connected to the second outer electrode 3b. This provides a structure in which a plurality of capacitor elements are electrically connected in parallel between the first outer electrode 3a and the second outer electrode 3b.

Further, the outer electrodes 3 each include, for example, an underlying electrode layer 30 and a plated layer 31. The outer electrodes 3 are not necessarily required to have such a layered structure. The outer electrodes 3 may include a resin electrode layer in addition to these layers in order to alleviate stress applied to the multilayer ceramic capacitor 1.

The underlying electrode layer 30 is formed, for example, by applying and baking a conductive paste including Cu as a main component. Further, the underlying electrode layer 30 may include a metal component other than Cu, a glass component, a ceramic material, and/or the like. Examples of the metal component other than Cu include Mg, Cr, Sr, Al, Na, and Fe. Further, examples of the glass component include an oxide of Ba, Sr, Si, Ca, Zn, Al, B, or the like. The ceramic component can include, as a main component, a component included in the dielectric layer 14 of the inner layer portion 11.

The underlying electrode layer can have a two-layer structure. When the underlying electrode layer has a two-layer structure, a first layer may include a metal component and a glass component, and a second layer may include a metal component and a resin. By including a resin in the underlying electrode layer, flexural strength can be improved. The second layer is not required to completely cover the first layer, and may cover a portion of the first layer.

The plated layer includes, for example, at least one kind of metal selected from Cu, Ni, Sn, Pb, Au, Ag, Pd, Bi, or Zn, or the like or an alloy including this metal. It is preferable that the percentage of the metal per unit volume in the plated layer be about 99 volume % or more. It is preferable for the plated layer not to include a glass component.

The plated layer 31 can have a two-layer structure. The two-layer structure can include, for example, a Ni plated layer on a surface of the underlying electrode layer 30 and a Sn plated layer on a surface of the Ni plated layer. The configuration of the plated layer 31 is not limited thereto.

The plated layer 31 can have a three-layer structure. The three-layer structure can be formed, for example, by sequentially disposing a Sn plated layer, a Ni plated layer, and a Sn plated layer over a surface of the underlying electrode layer 30, or by sequentially disposing a Ni plated layer and a Au plated layer. The Ni plated layer can prevent the underlying electrode layer from being eroded by solder, and the Sn plated layer can improve mountability.

The spacers 4 include a pair of first spacer 4a and second spacer 4b. The first spacer 4a is disposed on the first end surface C1 side as one side in the length direction L on the second main surface A2 side that is a substrate mounting surface of the capacitor body 1A, and the second spacer 4b is disposed on the second end surface C2 side as the other side. When the substrate mounting surface of the capacitor body 1A is the first side surface B1, the first spacer 4a is disposed on the first end surface C1 side as one side in the length direction L on the first side surface B1 side that is the substrate mounting surface of the capacitor body 1A, and the second spacer 4b is disposed on the second end surface C2 side as the other side.

The spacer 4 is disposed on the outer electrode 3 of the capacitor body 1A and on the second main surface A2 of the multilayer body 2 that is adjacent to this outer electrode 3 and on which the outer electrode 3 is not disposed. When the substrate mounting surface of the capacitor body 1A is the first side surface B1, the spacer 4 is disposed on the outer electrode 3 of the capacitor body 1A and on the first side surface B1 of the multilayer body 2 that is adjacent to this outer electrode 3 and on which the outer electrode 3 is not disposed.

In the present example embodiment, the configuration has been shown in which the outer electrodes 3 each include the underlying electrode layer 30 and the plated layer 31 covering the underlying electrode layer 30 and the spacers 4 are disposed on surfaces of the plated layers 31. However, the plated layers 31 are not necessarily required, and for example, the spacers 4 may be disposed on surfaces of the underlying electrode layers 30.

As depicted in FIG. 2, the spacers 4 each include a first region 41 and a second region 42 arranged in the lamination direction T such that the first region 41 is in contact with the outer electrode 3 and the second region 42 is not in contact with the outer electrode 3. When the substrate mounting surface of the capacitor body 1A is the first side surface B1, the first region 41 and the second region 42 are arranged in the width direction W, and the first region 41 is in contact with the outer electrode 3 and the second region 42 is not in contact with the outer electrode 3.

The first region 41 and the second region 42 arranged in the lamination direction T or the width direction W as described above are configured such that the first region 41 is disposed in contact with the capacitor body 1A and the second region 42 is disposed apart from the capacitor body 1A.

The first region 41 can include various components such as a metal component and a resin component. For example, when a large amount of a metal component is included, the ratio of volume to surface area of the metal component increases, and thus ESR of the multilayer ceramic electronic component decreases. On the other hand, when a larger amount of a resin component than metal powder is included, vibration of the multilayer ceramic capacitor can be damped by the resin component, and vibration transmitted to the mounting substrate can be reduced.

As the resin component forming the first region 41, for example, a resin such as a phenolic resin or an epoxy resin can be used.

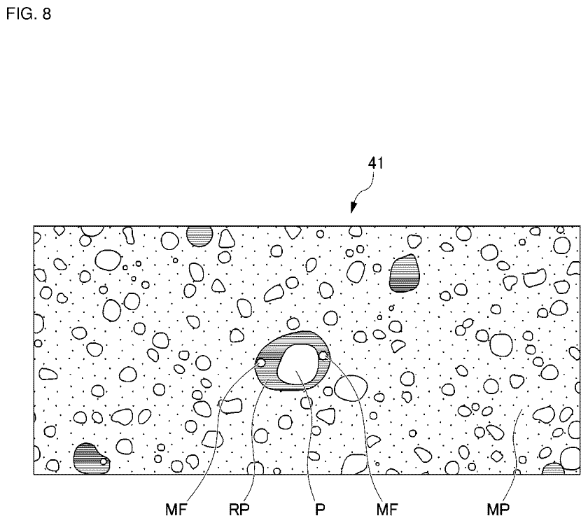

FIG. 8 depicts an example of a structure of the first region 41 when the first region 41 includes a phenolic resin. FIG. 8 is a partially enlarged view of a cross section of an interior region of the first region 41.

The first region 41 depicted in FIG. 8 includes either Cu or Ni and Sn as a metal powder. Cu and Ni may be coated with Ag. An intermetallic compound formed by adding Sn to either Cu or Ni is less likely to be deformed due to heat even when soldering is performed when the multilayer ceramic capacitor 1 is mounted on a mounting substrate, and can reliably maintain the shape of the first region 41. In particular, an intermetallic compound formed by adding Sn to an alloy of Cu and Ni is preferable as a component of the first region 41.

The phenolic resin is included in a metal region MP formed by the metal powder. The phenolic resin coats particles of the intermetallic compound and is dispersed so as to fill gaps between the particles. The phenolic resin may be in a state in which it does not completely coat the particles of the intermetallic compound. Further, by using the phenolic resin, the amount of a gas generated in heat treatment for forming the first region 41 can be reduced, and thus pores P in the first region 41 can be reduced. The phenolic resin may be exposed at a surface of the first region 41 and may cover at least a portion of the surface of the first region 41. By covering the surface of the first region 41 with the phenolic resin, smoothness of the surface of the first region 41 is improved, and mechanical strength of the spacer 4 can be increased.

Examples of the phenolic resin include novolac-type phenolic resins such as phenol novolac resin, phenol aralkyl resin, cresol novolac resin, tert-butylphenol novolac resin, and nonylphenol novolac resin, resol-type phenolic resins, and polyoxystyrenes such as poly(p-oxystyrene).

The first region 41 may include an epoxy resin or rosin besides the phenolic resin. Further, the first region 41 may include an epoxy resin or the like in addition to the phenolic resin.

As depicted in FIG. 8, metal powder MF may be included in a resin region RP including the phenolic resin. Shrinkage of the phenolic resin can be inhibited by the metal powder MF, and shrinkage stress caused by the phenolic resin can be alleviated.

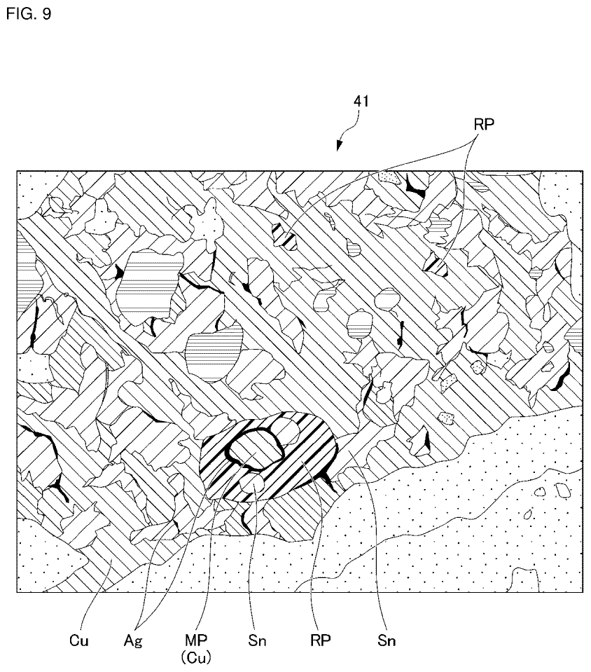

FIG. 9 depicts an example of a structure of the first region 41 when the first region 41 is formed using an epoxy resin. FIG. 9 is a partially enlarged view of a cross section of an interior region of the first region 41.

The first region 41 depicted in FIG. 9 includes a Sn region, the resin region RP, the metal region MP including Cu or including Cu and Ni, and an Ag region. The metal region MP is represented as Cu in the diagram, but includes either Cu or a metal including Cu and Ni. Further, the metal region MP may include Sn. In the metal including Cu and Ni, the Cu and Ni may be alloyed with each other. Alternatively, the metal including Cu and Ni may further include Sn to form an intermetallic compound. Sn may be included in the Ag region. These regions internally including Sn can be detected by WDX or EDX analysis.

Further, the resin region RP includes a region internally including Sn and the metal region MP including Cu or Cu and Ni covered with Ag. When the metal region MP includes Cu and Ni, the Cu and Ni may be alloyed with each other, or the metal region MP may further include Sn to form an intermetallic compound. In particular, in the resin region RP, a composition conjugated as a material is detected as it is.

The second region 42 has a higher Sn content percentage compared with the first region 41. When the Sn content percentage in the second region 42 is higher, Sn included in the second region 42 melts during heating at the time of mounting and contributes to bonding with a mounting substrate. Thus, the amount of solder used when the multilayer ceramic capacitor 1 is mounted on the mounting substrate can be reduced, and the occurrence of acoustic noise caused by upward spreading of the solder can be reduced or prevented.

It is preferable that an average particle size D50 of Sn particles included in the first region 41 and the second region 42 be set to about 5 μm or more, for example. When the average particle size D50 of Sn particles is less than about 5 μm, reactivity between metals decreases, and a large number of pores are generated inside the first region 41 and the second region 42. Thus, the strength of the first region 41 and the second region 42 decreases.

The second region 42 has a high resin content percentage compared with the first region 41. By setting the resin content percentage of the second region 42 high, an adhesion state between the second region 42 and the first region 41 can be stably kept. Further, the resin softens and flows due to heat of reflow during mounting of the multilayer ceramic capacitor 1. Thus, in association with this, Sn particles flow, and the probability of contact between Sn particles or between solder used in the mounting and the Sn particles increases. Accordingly, a metal network is easily formed, and electrical and physical bonding can be strengthened. Further, a reductive action from the resin is exhibited. Thus, increasing the amount of the resin can also improve an effect of removing an oxide film of the metal.

As depicted in FIG. 2, in the first region 41 and the second region 42 arranged in the lamination direction T, the first region 41 has a larger thickness in the lamination direction T than the second region 42. When the substrate mounting surface of the capacitor body 1A is the first side surface B1, the first region 41 and the second region 42 are arranged in the width direction W, and the first region 41 has a larger thickness in the width direction W than the second region 42.

When the first region 41 and the second region 42 are arranged in the lamination direction T, before mounting of the multilayer ceramic capacitor 1, the thickness of the first region 41 in the lamination direction T is about 50 μm or more and about 250 μm or less, and the thickness of the second region 42 in the lamination direction T is about 15 μm or more and about 200 μm or less, for example.

When the thickness of the first region 41 in the lamination direction T is set smaller than about 50 μm, a distance between the mounting substrate and the multilayer ceramic capacitor 1 becomes short, and it becomes difficult to solve a problem of acoustic noise. On the other hand, when the thickness of the first region 41 in the lamination direction T is set larger than about 250 μm, the first region 41 becomes liable to be detached from the capacitor body 1A due to external stress.

Further, when the thickness of the second region 42 in the lamination direction T is set smaller than about 15 μm, the volume of the second region 42 decreases, and thus adhesion strength after reflow decreases. On the other hand, when the thickness of the second region 42 in the lamination direction T is set larger than about 200 μm, the second region 42 becomes liable to be detached due to external stress.

When the substrate mounting surface of the capacitor body 1A is the first side surface B1, the thickness of the first region 41 in the width direction W is about 50 μm or more and about 250 μm or less, and the thickness of the second region 42 in the width direction W is about 15 μm or more and about 200 μm or less, for example.

After mounting of the multilayer ceramic capacitor 1 in which the first region 41 and the second region 42 are arranged in the lamination direction T, that is, in a mounting structure in which the second region 42 is connected to a mounting substrate 51, the thickness of the second region 42 in the lamination direction T after the connection is about 0.1 μm or more and about 200 μm or less, for example.

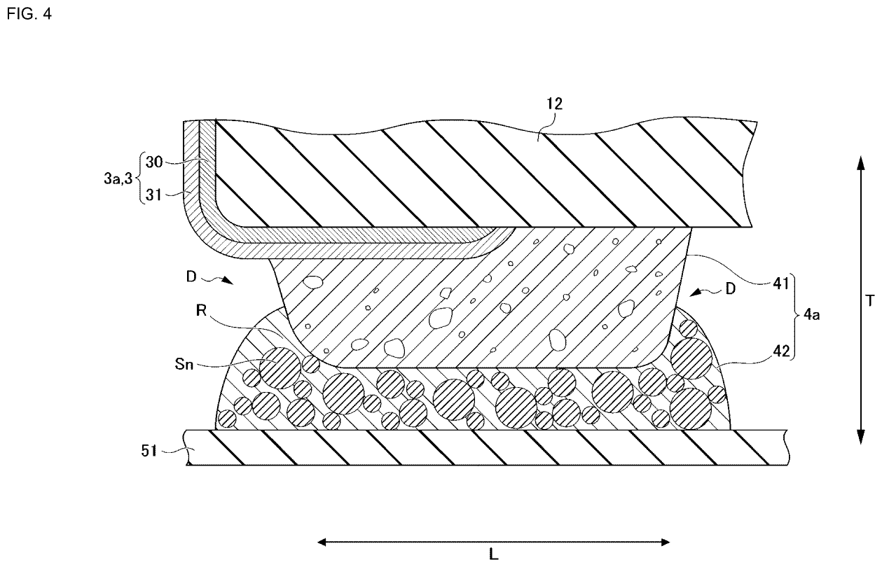

As depicted in FIG. 4, after mounting, the maximum length of the second region 42 in the length direction L is longer than the maximum length of the first region 41 in the length direction L.

Further, the maximum length of the second region 42 in the width direction W is longer than the maximum length of the first region 41 in the width direction W.

Due to such a dimensional difference between the first region 41 and the second region 42, a concave portion D is formed in a side surface of the spacer 4. Further, when solder is used in mounting, excess molten solder is trapped in the concave portion D in the spacer 4 in which the concave portion D is formed in the side surface. Thus, the spacer 4 in which the concave portion D is formed is excellent in an effect of reducing or preventing acoustic noise compared with a spacer in which the concave portion D is not formed.

When the substrate mounting surface of the capacitor body 1A is on the first side surface B1 side and the first region 41 and the second region 42 are arranged in the width direction W, the thickness of the second region in the width direction W after mounting in which the second region is connected to the mounting substrate 51 is about 0.1 μm or more and about 200 μm or less, for example. Further, the maximum length of the second region 42 in the length direction L is longer than the maximum length of the first region 41 in the length direction L, and the maximum length of the second region 42 in the lamination direction T is longer than the maximum length of the first region 41 in the lamination direction T.

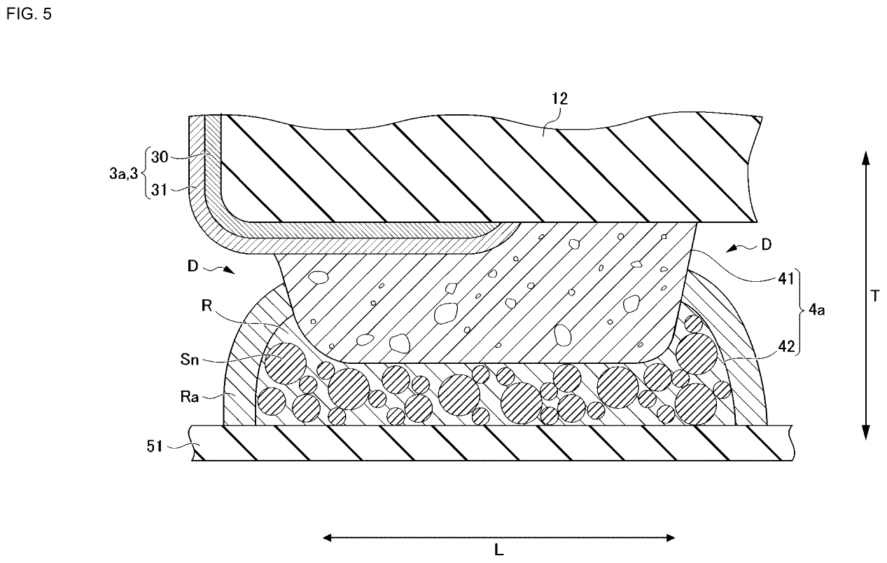

Further, after mounting in which the multilayer ceramic capacitor 1 is connected to the mounting substrate 51, as depicted in FIG. 5, a resin Ra including the same component as a resin R included in the second region 42 may be present on a surface of the second region 42 and on a surface of the mounting substrate 51. In addition, the resin Ra may be present on a surface of the capacitor body 1A. The resin eluted from the second region 42 contributes to the connection between the spacer 4 and the mounting substrate 51. Accordingly, the amount of solder used for the connection can be reduced, and acoustic noise can be reduced or prevented.

Further, a structure of the spacer 4 after mounting can be adjusted on the basis of the kind, the blending amount, and the like of resin used when the first region 41 and the second region 42 are formed.

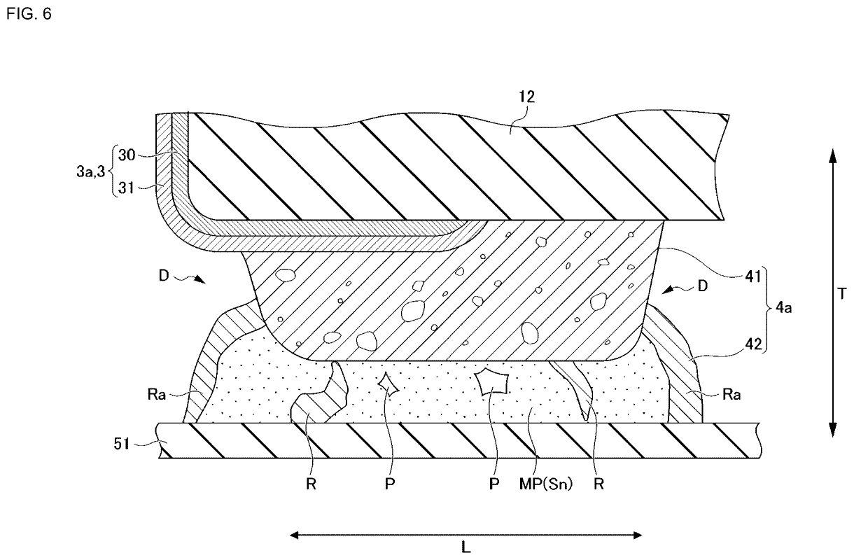

For example, when the second region 42 is formed using a thermosetting resin in which a phenolic resin and an epoxy resin are mixed as resin components, Sn in the second region 42 melts out in mounting on a mounting substrate, and a portion of the Sn is absorbed by the first region 41. Further, most of the resin of the second region 42 is discharged to the periphery of the second region 42. Thus, the spacer 4 after mounting has a structure like one depicted in FIG. 6. When a thermosetting resin is used, not only adhesion between solder used in mounting and a metal but also adhesion by the thermosetting resin can be generated. At this time, when only a phenolic resin is included as a resin component of the first region 41, it is possible to facilitate maintenance of a shape of the first region 41.

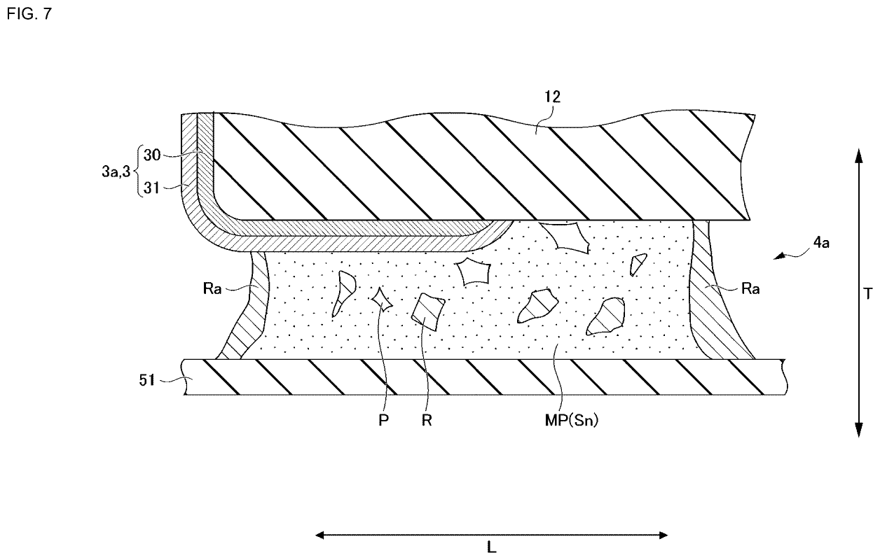

On the other hand, for example, when the first region 41 and the second region 42 are formed using a non-thermosetting resin including only a phenolic resin, only an epoxy resin, or only rosin, Sn in the second region 42 melts out, and a large portion thereof is absorbed by the first region 41. Further, because most of the resin of the second region 42 is discharged to the periphery of the second region, the spacer 4 after mounting has a structure like one depicted in FIG. 7.

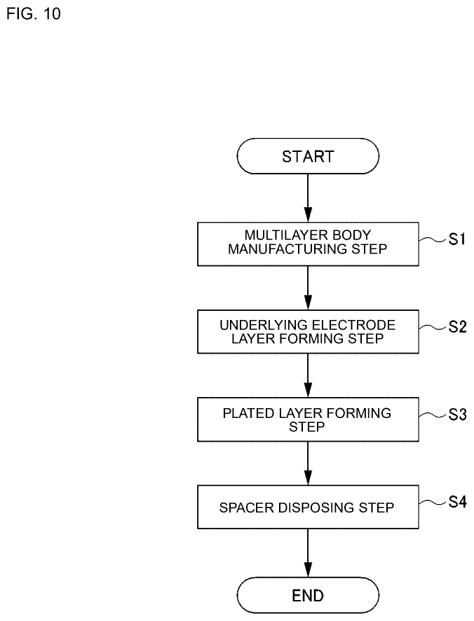

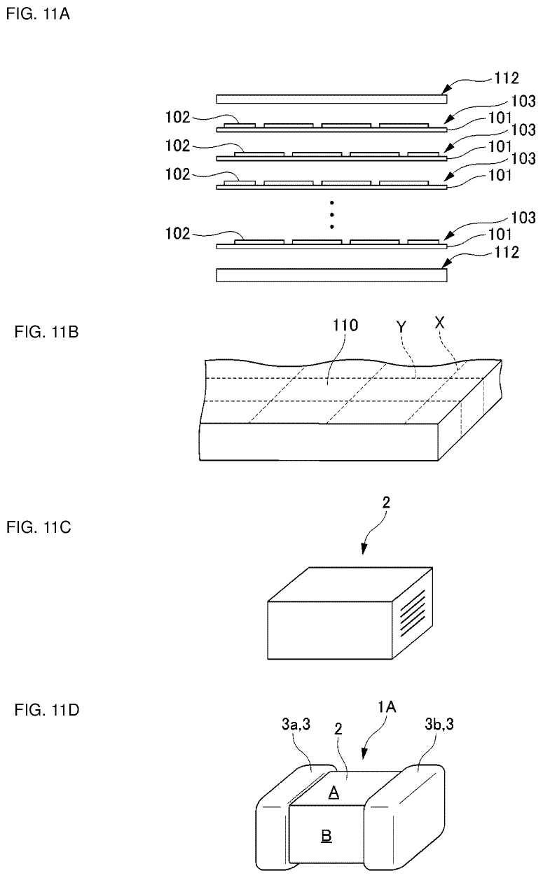

FIG. 10 is a flowchart for explaining a non-limiting example of a manufacturing method for the multilayer ceramic capacitor 1. The manufacturing method for the multilayer ceramic capacitor 1 includes a multilayer body manufacturing step S1, an underlying electrode layer forming step S2, a plated layer forming step S3, and a spacer disposing step S4. FIGS. 11A to 11D are diagrams for explaining the multilayer body manufacturing step S1, the underlying electrode layer forming step S2, and the plated layer forming step S3.

Ceramic slurry including ceramic powder, a binder, and a solvent is formed in a sheet shape on a surface of a carrier film using a die coater, a gravure coater, a micro-gravure coater, or the like to fabricate a ceramic green sheet 101 for lamination to serve as the dielectric layer 14. Next, a conductor paste is printed in a strip shape on the ceramic green sheet 101 for lamination by screen printing, ink-jet printing, gravure printing, or the like to print a conductive pattern 102 to serve as the inner electrode layer 15 on a surface of the ceramic green sheet 101 for lamination, thereby fabricating a material sheet 103.

Subsequently, as depicted in FIG. 11A, a plurality of material sheets 103 are stacked such that the conductive patterns 102 are oriented in the same direction and, between adjacent material sheets 103, the conductive patterns 102 are offset from each other in the length direction by, for example, a half pitch. Further, ceramic green sheets 112 for the outer layer portion to serve as the outer layer portions 12 are stacked on both sides of the plurality of stacked material sheets 103.

The stacked material sheets 103 and the ceramic green sheets 112 for the outer layer portion are pressure-bonded by isostatic pressing or the like to fabricate a mother block 110 depicted in FIG. 11B.

Next, the mother block 110 is cut along cutting lines X depicted in FIG. 11B and cutting lines Y intersecting the cutting lines X and is fired to manufacture a plurality of multilayer bodies 2 depicted in FIG. 11C.

Subsequently, the underlying electrode layers 30 are formed by applying a conductive paste including Cu to the end surfaces C of the multilayer body 2 and baking the conductive paste. The underlying electrode layers 30 are formed so as to extend not only on the end surfaces C on both sides of the multilayer body 2 but also to the main surface A side and the side surface B side of the multilayer body 2 to cover also portions of the main surfaces A on the end surface C side. However, the underlying electrode layer 30 is not limited thereto and may include another metal or another component, and double underlying electrode layers may be disposed.

Next, the plated layers 31 are formed on surfaces of the underlying electrode layers 30, thereby manufacturing the capacitor body 1A depicted in FIG. 11D. The plated layer 31 can include a Ni plated layer and a Sn plated layer disposed on a surface of the Ni plated layer, but is not limited thereto.

The spacer disposing step S4 includes the following first region forming step and second region forming step.

A paste for the first region used for forming the first regions 41 is prepared. Examples of the paste for the first region include the following phenolic resin-based paste and epoxy resin-based paste.

The paste for the first region includes a metal including Cu, Ni, Sn, and Ag, a phenolic resin, a solvent, and an additive.

Examples of the phenolic resin include novolac-type phenolic resins such as phenol novolac resin, phenol aralkyl resin, cresol novolac resin, tert-butylphenol novolac resin, and nonylphenol novolac resin, resol-type phenolic resins, and polyoxystyrenes such as poly(p-oxystyrene).

The paste for the first region is applied, on the second main surface A2 side that is a substrate mounting surface of the capacitor body 1A, to the first end surface C1 side as one side in the length direction L, on which the first spacer 4a is to be disposed, and to the second end surface C2 side as the other side in the length direction L, on which the second spacer 4b is to be disposed. Further, when the substrate mounting surface of the capacitor body 1A is the first side surface B1, the paste for the first region is applied, on the first side surface B1 side that is the substrate mounting surface of the capacitor body 1A, to the first end surface C1 side as one side in the length direction L, on which the first spacer 4a is to be disposed, and to the second end surface C2 side as the other side in the length direction L, on which the second spacer 4b is to be disposed.

A screen printing method, a dispensing method, or the like can be used for the application of the paste for the first region.

After the paste for the first region is applied, a heating step is executed. When at least a portion of the metal in the paste forms an intermetallic compound and the metal region MP is formed, a portion of the phenolic resin is captured into the metal region MP and a portion of the phenolic resin is cured while being discharged from the metal region MP, thereby forming the first regions 41 of the spacers 4 bonded to the capacitor body 1A.

The paste for the first region includes Sn, Cu coated with Ag or a metal including Cu and Ni coated with Ag instead of Cu, a resin made of an epoxy resin, and a solvent.

The epoxy resin is a bisphenol A type epoxy resin. The solvent is, for example, diethylene glycol monobutyl ether, diethylene glycol monoethyl ether, or diethylene glycol monomethyl ether. Further, the paste for the first region does not include a curing agent such as a phenolic resin or imidazole.

The volume ratio of Sn with respect to the total volume of the metal is about 70% or more and about 90% or less, for example. The volume ratio of the metal with respect to the resin is about 70% or more and about 90% or less, for example.

As the forming step with the epoxy resin-based paste, a step similar to that with the above-described phenolic resin-based paste can be used.

A metal paste for forming the second regions 42 is disposed on surfaces of the first regions 41 by a dispensing method or mask printing. An epoxy resin or a phenolic resin may be added to the metal paste for the second regions 42, and a catalyst such as imidazole and the like may be added thereto.

As the included resin, an epoxy resin or a phenolic resin can be used. However, by mixing these resins and further adding a catalyst such as imidazole, not only solder but also an adhesion force by the resin can be utilized for connection between the mounting substrate and the multilayer ceramic electronic component in mounting. Thus, adhesion strength is improved and robust connection is enabled.

The second regions 42 can be formed by disposing the metal paste for forming the second regions 42 on the first regions 41 and then performing heat treatment, for example, at about 100 to about 200 °C for approximately about 5 to about 20 minutes.

Heat treatment for forming the first regions 41 or the second regions 42 can be performed in each of the first region forming step and the second region forming step as described above. However, the heat treatment may be simultaneously performed depending on components of the paste for the first region and the paste for the second region.

Although example embodiments of the present invention have been described above, the present invention is not limited thereto, and can be carried out in various examples.

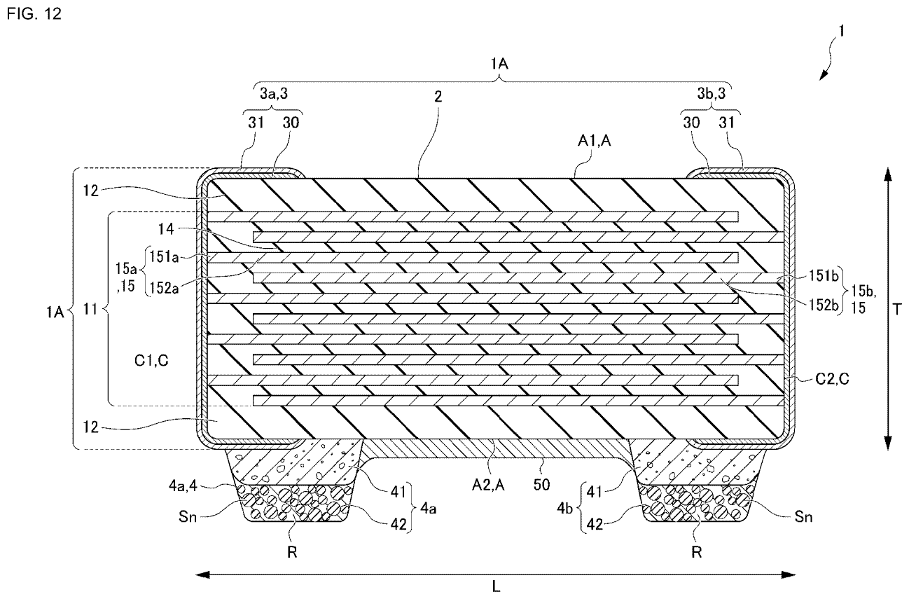

For example, as depicted in FIG. 12, an insulating material 50 can be disposed between the first spacer 4a and the second spacer 4b so as to cover at least a portion of at least one of the first spacer 4a or the second spacer 4b and at least a portion of the second main surface A2 or the first side surface B1 of the multilayer body 2. Further, in addition thereto, the insulating material 50 may be disposed so as to enter a gap between the first region 41 and the second main surface A2 or the first side surface B1 of the multilayer body 2.

By disposing the insulating material 50, adhesion forces between the spacer 4 and the outer electrode 3 and between the spacer 4 and the multilayer body 2 can be improved.

FIG. 12 depicts a form in which the insulating material 50 is continuously disposed between the first region 41 of the first spacer 4a and the first region 41 of the second spacer 4b. In such a form, the insulating material 50 is allowed to have a shape in which a length in the width direction W regarding a central portion in the length direction L is shorter than lengths in the width direction W regarding both end portions in the length direction L.

The insulating material 50 can be continuously disposed between the first spacer 4a and the second spacer 4b. However, it is not necessarily required to be continuously disposed. For example, the insulating material 50 may be so disposed as to be divided into a portion covering a portion of the first spacer 4a and a portion of the second main surface A2 or the first side surface B1 of the multilayer body 2 and a portion covering a portion of the second spacer 4b and a portion of the second main surface A2 or the first side surface B1 of the multilayer body 2.

The insulating material 50 can cover the entire capacitor body 1A. When the insulating material 50 covers the entire capacitor body 1A, cushioning properties of the insulating material 50 are enhanced, and impact resistance when an impact is applied to the multilayer ceramic capacitor 1 can be improved.

The insulating material 50 can include an insulating resin. A surface of the insulating resin may be coated with an insulating water-repellent treatment agent. Flexural strength is improved by forming the insulating material from the insulating resin. Further, moisture resistance is improved by coating the insulating material with the insulating water-repellent treatment agent. The insulating resin may include a ceramic, glass, or the like. The insulating material 50 may include only the water-repellent treatment agent.

As a material of the insulating material 50, an epoxy resin can be used as a main component, and a phenolic resin can be combined with the epoxy resin as a curing agent. As other curing agents, acid anhydride-based, amine-based, or ester-based curing agents, or the like, can be used. A curing accelerator may further be added to the epoxy resin. Further, the insulating material 50 may include, for example, carbon, Co, Al, Cu, N, or Cr. Because the hue of the insulating material 50 can be made different from the hue of the capacitor body 1A, direction selection in mounting on a substrate can be facilitated.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a capacitor body including:
a multilayer body including an inner layer portion in which dielectric layers and inner electrode layers are alternately laminated, two main surfaces facing each other in a lamination direction, two end surfaces facing each other in a length direction intersecting the lamination direction, and two side surfaces facing each other in a width direction intersecting the lamination direction and the length direction; and
two outer electrodes that are each connected to the inner electrode layers and each cover a respective one of the two end surfaces and, continuously from the end surface, a portion of the two main surfaces facing each other and a portion of the two side surfaces facing each other, at a respective one of the two end surfaces; and
two spacers located on any one surface of the two main surfaces and the two side surfaces of the multilayer body; wherein
the two spacers include a first region and a second region arranged in a direction in which the multilayer body and the spacers are arranged such that the first region is in contact with a respective one of the two outer electrodes and the second region is not in contact with the two outer electrodes; and
the second region has a higher Sn content percentage compared with the first region.

2. The multilayer ceramic electronic component according to claim 1, wherein, in the first region and the second region arranged in the direction in which the multilayer body and the spacers are arranged, the first region has a larger thickness in the direction in which the multilayer body and the spacers are arranged than the second region.

3. The multilayer ceramic electronic component according to claim 2, wherein the thickness of the first region is about 50 μm or more and about 250 μm or less.

4. The multilayer ceramic electronic component according to claim 2, wherein the thickness of the second region is about 15 μm or more and about 200 μm or less.

5. The multilayer ceramic electronic component according to claim 1, wherein the second region includes a thermosetting resin.

6. A multilayer ceramic electronic component comprising:
a capacitor body including:
a multilayer body including an inner layer portion in which dielectric layers and inner electrode layers are alternately laminated, two main surfaces facing each other in a lamination direction, two end surfaces facing each other in a length direction intersecting the lamination direction, and two side surfaces facing each other in a width direction intersecting the lamination direction and the length direction; and
two outer electrodes that are each connected to the inner electrode layers and each cover a respective one of the two end surfaces and, continuously from the end surface, a portion of the two main surfaces facing each other and a portion of the two side surfaces facing each other, at a respective one of the two end surfaces; and
two spacers located on any one surface of the two main surfaces and the two side surfaces of the multilayer body; wherein
the two spacers include a first region and a second region arranged in a direction in which the multilayer body and the spacers are arranged such that the first region is in contact with a respective one of the two outer electrodes and the second region is not in contact with the two outer electrodes; and
the second region has a higher resin content percentage compared with the first region.

7. The multilayer ceramic electronic component according to claim 6, wherein in the first region and the second region arranged in the direction in which the multilayer body and the spacer are arranged, the first region has a larger thickness in the direction in which the multilayer body and the spacer are arranged than the second region.

8. The multilayer ceramic electronic component according to claim 7, wherein the thickness of the first region is about 50 μm or more and about 250 μm or less.

9. The multilayer ceramic electronic component according to claim 7, wherein the thickness of the second region is about 15 μm or more and about 200 μm or less.

10. The multilayer ceramic electronic component according to claim 6, wherein the second region includes a thermosetting resin.

11. A mounting structure for a ceramic electronic component, the mounting structure comprising:
the multilayer ceramic electronic component according to claim 1 connected to a mounting substrate.

12. The mounting structure of the ceramic electronic component according to claim 11, wherein
a thickness of the second region in the direction in which the multilayer body and the spacer are arranged after the connection to the mounting substrate is about 0.1 μm or more and about 200 μm or less;
a maximum length of the second region in the length direction are arranged is longer than a maximum length of the first region in the length direction; and
a maximum length of the second region in the width direction are arranged is longer than a maximum length of the first region in the width direction.

13. The mounting structure of the ceramic electronic component according to claim 11, wherein a resin including a same component as a resin included in the second region is present on a surface of the second region and on a surface of the mounting substrate.

14. The mounting structure of the ceramic electronic component according to claim 11, wherein a resin including a same component as a resin included in the second region is present on a surface of the second region and on a surface of the capacitor body.

15. A mounting structure for a ceramic electronic component, the mounting structure comprising:
the multilayer ceramic electronic component according to claim 6 connected to a mounting substrate.

16. The mounting structure of the ceramic electronic component according to claim 15, wherein
a thickness of the second region in the direction in which the multilayer body and the spacer are arranged after the connection to a mounting substrate is about 0.1 μm or more and about 200 μm or less;
a maximum length of the second region in the length direction is longer than a maximum length of the first region in the length direction; and
a maximum length of the second region in the width direction is longer than a maximum length of the first region in the width direction.

17. The mounting structure of the ceramic electronic component according to claim 15, wherein a resin including a same component as a resin included in the second region is present on a surface of the second region and on a surface of the mounting substrate.

18. The mounting structure of the ceramic electronic component according to claim 15, wherein a resin including a same component as a resin included in the second region is present on a surface of the second region and on a surface of the capacitor body.
